(19) United States
(12) Patent Application Publication
(10) Pub. No.: US 2012/0037432 A1
(43) Pub. Date: Feb. 16, 2012

(54) PLAYARD SET AND PLACING MECHANISM THEREOF

(76) Inventors: Joseph F. Fiore, JR., Lebanon, PA (US); Jonathan Mountz, Birdsboro, PA (US); Jonathan M. Pacella, Coatesville, PA (US); Curtis M. Hartenstine, Birdsboro, PA (US); Joseph Fiore, III, Plano, TX (US)

(21) Appl. No.: 13/204,734

(22) Filed: Aug. 8, 2011

Related U.S. Application Data
(60) Provisional application No. 61/401,310, filed on Aug. 11, 2010.

(51) Int. Cl. G01G 19/52; G01G 23/18; A47D 13/06

(52) U.S. Cl. 177/45; 177/144

(57) ABSTRACT

A playard set includes a playard and a placing mechanism. The playard has a first top corner structure and a second top corner structure. The placing mechanism is detachably disposed on the playard. The placing mechanism includes a first corner connecting structure and a second corner connecting structure, a support frame, a holding body, and a weight measuring device. The first and the second corner connecting structures are detachably disposed on the first and the second top corner structures of the playard respectively. The support frame is cantilevered from the first corner connecting structure. The holding body is suspended from the support frame for holding an infant. The weight measuring device is disposed on the first corner connecting structure and connected to the support frame for measuring a corresponding weight value when the holding body is pressed downward along with the support frame.

### CROSS REFERENCE TO RELATED APPLICATIONS

This application claims the benefit of U.S. Provisional Application No. 61/401,310, which was filed on Aug. 11, 2010, and is incorporated herein by reference.

### BACKGROUND OF THE INVENTION

1. Field of the Invention

The present invention relates to a playard set and a placing mechanism thereof, and more specifically, to a playard set having a weight measuring function and a placing mechanism thereof.

2. Description of the Prior Art

For meeting user needs, many additional accessories are disposed on a playard to increase convenience of the playard in use, such as a bassinet or a diaper changing table. Furthermore, some playards contain a variety of electronic accessories to soothe and entertain an infant placed thereon. However, the aforementioned accessories provide little information about the infant to a caregiver. Thus, the caregiver usually has to wait until next visit to the doctor in order to accurately assess how much the infant weighs and if he is growing according to recommended norms. Besides, these accessories also provide no helpful information for taking care of the infant, such as what the current time or the current temperature is. This may cause the caregiver much inconvenience in taking care of the infant.

### SUMMARY OF THE INVENTION

The present invention provides a playard set including a playard and a placing mechanism. The playard has a first top corner structure and a second top corner structure. The placing mechanism is detachably disposed on the playard. The placing mechanism includes a first corner connecting structure and a second corner connecting structure, a support frame, a holding body, and a weight measuring device. The first and second corner connecting structures are disposed on the first and the second top corner structures of the playard respectively. The support frame is cantilevered from the first corner connecting structure. The holding body is suspended from the support frame for holding an infant. The weight measuring device is disposed on the first corner connecting structure and connected to the support frame for measuring a corresponding weight value when the holding body is pressed downward along with the support frame.

The present invention further provides a placing mechanism detachably disposed on an infant carrying apparatus. The placing mechanism includes a first corner connecting structure and a second corner connecting structure, a support frame, a holding body, and a weight measuring device. The first and the second corner connecting structures are detachably disposed on the infant carrying apparatus. The support frame is extended from the first corner connecting structure. The holding body is suspended from the support frame for holding an infant. The weight measuring device is disposed on the first corner connecting structure and connected to the support frame for measuring a corresponding weight value when the holding body is pressed downward along with the support frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial diagram of a playard set according to an embodiment of the present invention.

FIG. 2 is an exploded diagram of a time-and-temperature display device in FIG. 1.

FIG. 3 is a diagram of the time-and-temperature display device and a weight measuring device being disposed on a first corner connecting structure and a second corner connecting structure respectively according to another embodiment of the present invention.

### DETAILED DESCRIPTION

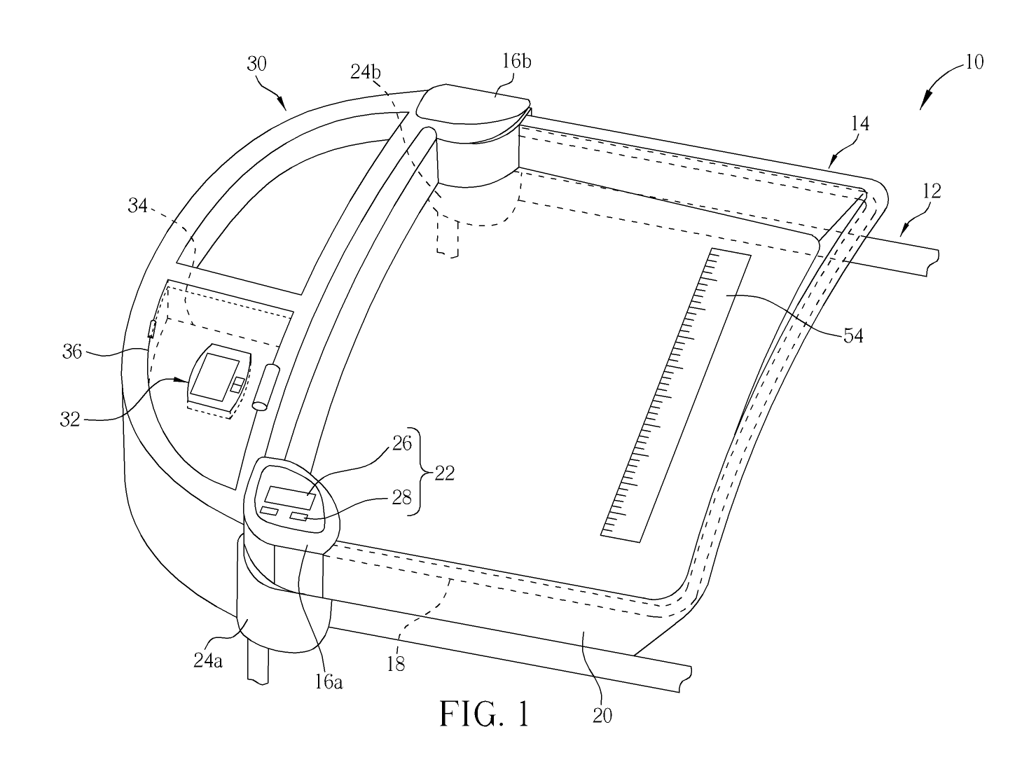

Please refer to FIG. 1, which is a partial diagram of a playard set 10 according to an embodiment of the present invention. As shown in FIG. 1, the playard set 10 includes a playard 12 (partially shown in FIG. 1) and a placing mechanism 14. The placing mechanism 14 is detachably disposed on the playard 12 for allowing a caregiver to place an infant thereon. The placing mechanism 14 is preferably a diaper changing table. The mechanical design of the placing mechanism 14 is described in detail as follows.

The placing mechanism 14 includes a first corner connecting structure 16a and a second corner connecting structure 16b, a support frame 18, a holding body 20, and a weight measuring device 22. The first corner connecting structure 16a and the second corner connecting structure 16b are detachably disposed on a first top corner structure 24a and a second top corner structure 24b of the playard 12 respectively so as to fix the placing mechanism 14 onto the playard 12. As for the connection design between the first and the second corner connecting structures 16a, 16b and the first and the second top corner structures 24a, 24b, it is commonly seen in the prior art and the related description is therefore omitted herein. To be noted, disposal of the placing mechanism 14 can also be applied to other infant carrying apparatus, such as a stroller, a high chair and a car seat.

The support frame 18 is preferably extended (cantilevered, for example) from the first corner connecting structure 16a for supporting the holding body 20 above the playard 12. The support frame 18 is preferably a U-shaped tube. The holding body 20 is suspended from the support frame 18 for holding an infant. The holding body 20 is preferably made of fabric material. The weight measuring device 22 is disposed on the first corner connecting structure 16a and connected to the support frame 18 for measuring a corresponding weight value when the holding body 20 is pressed downward along with the support frame 18. The weight measuring device 22 preferably comprises a strain gage for measuring the strain applied to the support frame 18, so as to translate and output a corresponding weight value of an infant placed on the holding body 20. In this embodiment, the weight measuring device 22 has a display interface 26 and a button interface 28. The display interface 26 is preferably a liquid crystal display (LCD) monitor for displaying the weight value. The button interface 28 is used for performing operations of the weight measuring device 22, such as powering on the weight measuring device 22, resetting the readout of the weight measuring device 22, or switching the weight measuring device 22 between metric and imperial units for weight measurement.

As for the linkage design between the support frame 18 and the weight measuring device 22, which is used for allowing the support frame 18 to drive the weight measuring device 22 to measure a corresponding weight value of an infant placed on the holding body 20 when the holding body 20 is pressed downward by the infant, it is commonly seen in the prior art (e.g. utilizing a socket of the weight measuring device 22 to mount the support frame 18 via a snap button), and the related description is omitted herein.

Besides, as shown in FIG. 1, the playard 12 includes an organizer 30, and the playard set 10 further includes a time-and-temperature display device 32. The organizer 30 is connected to the first and the second top corner structures 24a, 24b of the playard 12 and includes at least one containing structure 34 (two shown in FIG. 1) and a lid 36. The containing structure 34 is used for containing objects, such as infant care supplies (e.g. bottles or diapers), so as to make the objects easily accessible when a caregiver takes care of an infant placed on the placing mechanism 14 or the playard 12. The lid 36 is pivotally connected to the containing structure 34 for protection of the objects contained in the containing structure 34. The time-and-temperature display device 32 is mounted on the lid 36.

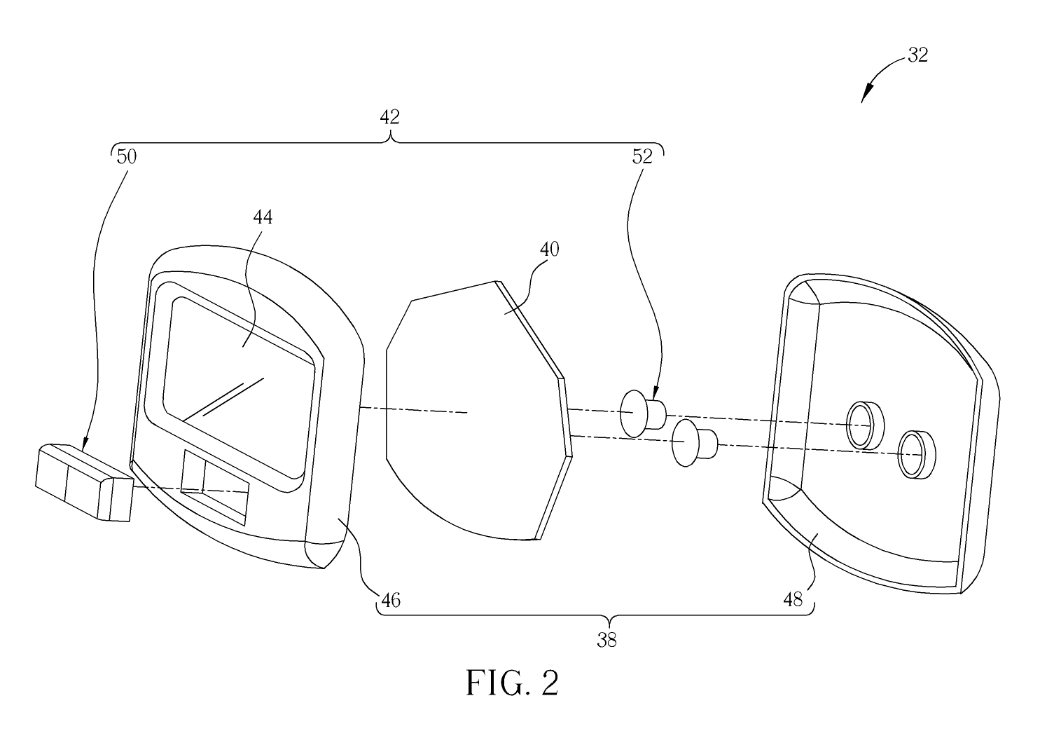

In this embodiment, the design of the time-and-temperature display device 32 is depicted as shown in FIG. 2, which is an exploded diagram of the time-and-temperature display device 32 in FIG. 1. As shown in FIG. 2, the time-and-temperature display device 32 includes a case 38, a circuit board 40, a button interface 42, and a display interface 44. The circuit board 40 is preferably a battery-powered printed circuit board assembly (PCBA). The case 38 includes a front housing 46 and a rear housing 48. The front housing 46 is used for containing the circuit board 40 cooperatively with the rear housing 48. The button interface 42 is connected to the circuit board 40 and includes at least one front button 50 and at least one rear button 52 (two shown in FIG. 2 respectively). The front button 50 is disposed on the front housing 46 as a function button for performing basic functions of the time-and-temperature display device 32, such as powering on the time-and-temperature display device 32 or toggling display of the time-and-temperature display device 32 between the current time and the current temperature. The rear button 52 is disposed on the rear housing 48 as a setup button for setting the internal clock of the time-and-temperature display device 32 to the proper time, switching the internal clock of the time-and-temperature display device 32 from the standard time to the military time, etc. The display interface 44 is electrically connected to the circuit board 40 and mounted on the front housing 46 for displaying the current time and the current temperature. The display interface 44 is preferably a light emitting diode (LED) monitor.

In such a configuration, when a caregiver places an infant on the holding body 20 for taking care of the infant (e.g. changing the infant's diaper), the holding body 20 is pressed downward by the weight of the infant to cause a torque to be applied to the support frame 18. At the same time, the support frame 18 drives the weight measuring device 22 to measure a corresponding weight value of the infant according to the applied torque, and then the display interface 26 displays the weight value. Accordingly, the caregiver can immediately know the weight information of the infant so as to accurately assess how much the infant weighs and if he is growing according to recommended norms. Furthermore, via disposal of the time-and-temperature display device 32 on the lid 36 of the organizer 30, the playard set 10 can also provide feedback to the caregiver about what the current temperature is and what the current time is, so as to help the caregiver ensure that the infant is in a comfortable environment and measure the duration of the infant's nap conveniently.

For offering further information about the infant to the caregiver, as shown in FIG. 1, a ruler pattern 54 can be further disposed (i.e. printed, attached or sewed, etc.) on the holding body 20. Thus, the caregiver can measure a height value of the infant placed on the holding body 20 via the ruler pattern 54, so that the caregiver can keep track of the height of the infant as he grows.

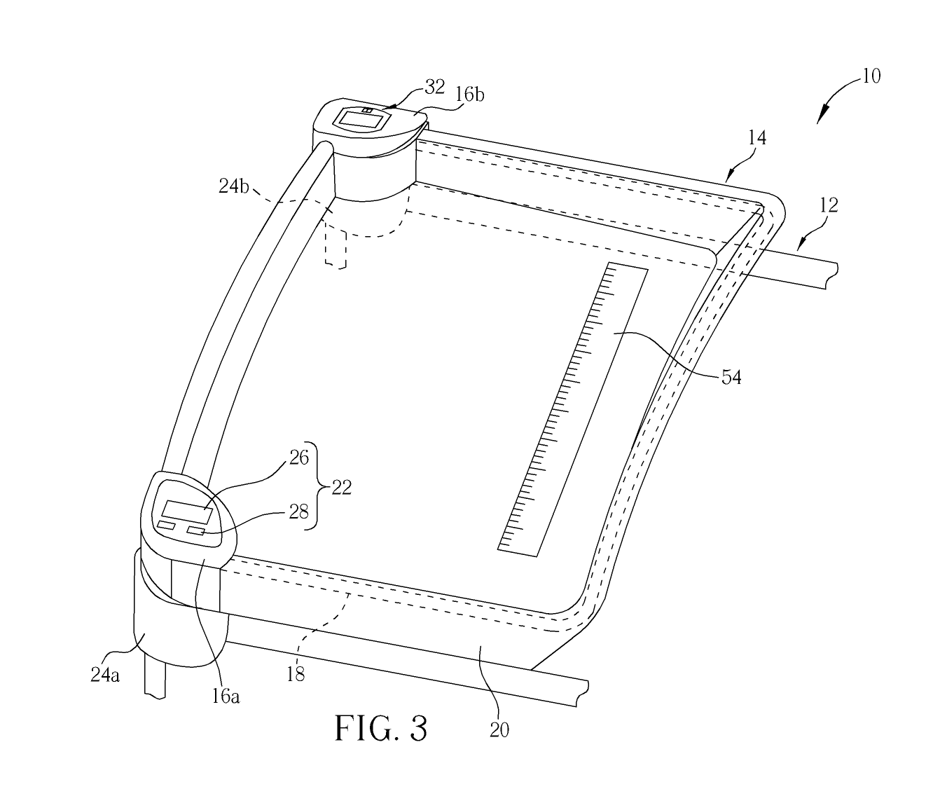

It should be mentioned that the organizer 30 and the time-and-temperature display device 32 are an omissible component for simplifying the mechanical design of the playard set 10. Furthermore, disposal of the time-and-temperature display device 32 is not limited to the said embodiment. That is to say, the time-and-temperature display device 32 can be affixed to an injection molded plastic part of the placing mechanism 14 or a stiffened fabric piece of the playard 12 instead. For example, the time-and-temperature display device 32 can be disposed in the second corner connecting structure 16b instead as shown in FIG. 3, which is a diagram of the time-and-temperature display device 32 and the weight measuring device 22 being disposed on the first and the second corner connecting structures 16a and 16b respectively according to another embodiment of the present invention. In another embodiment of the present invention, the time-and-temperature display device 32 can also be directly integrated with the weight measuring device 22 such that the weight measuring device 22 can display the current time and the current temperature.

Compared with the prior art, the playard set provided by the present invention utilizes the weight measuring device to measure a corresponding weight value of an infant when a caregiver places the infant on the holding body of the placing mechanism. Accordingly, the caregiver can immediately know the weight information of the infant. Furthermore, via additional disposal of the time-and-temperature display device, the playard set can also provide feedback to the caregiver about what the current temperature is and what the current time is, so as to help the caregiver ensure that the infant is in a comfortable environment and measure the duration of the infant's nap conveniently. Thus, convenience of the playard set in taking care of an infant can be increased greatly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A playard set comprising:
a playard having a first top corner structure and a second top corner structure; and
a placing mechanism detachably disposed on the playard, the placing mechanism comprising:
a first corner connecting structure and a second corner connecting structure detachably disposed on the first and the second top corner structures of the playard respectively;
a support frame cantilevered from the first corner connecting structure;
a holding body suspended from the support frame for holding an infant; and
a weight measuring device disposed on the first corner connecting structure and connected to the support frame for measuring a corresponding weight value when the holding body is pressed downward along with the support frame.

2. The playard set of claim 1, wherein the support frame is a U-shaped tube.

3. The playard set of claim 1, wherein the weight measuring device comprises a strain gage.

4. The playard set of claim 1, wherein the weight measuring device has a display interface and a button interface, the display interface is used for displaying the weight value, and the button interface is used for performing operations of the weight measuring device.

5. The playard set of claim 1 further comprising:
a time-and-temperature display device disposed on one of the placing mechanism and the playard for displaying a current time and a current temperature.

6. The playard set of claim 5, wherein the weight measuring device is further integrated with the time-and-temperature display device such that the weight measuring device can display the current time and the current temperature.

7. The playard set of claim 5, wherein the time-and-temperature display device is disposed on the second corner connecting structure.

8. The playard set of claim 5, wherein the playard comprises an organizer connected thereto, and the time-and-temperature display device is disposed on the organizer.

9. The playard set of claim 8, wherein the organizer is connected to the first top corner structure and the second top corner structure.

10. The playard set of claim 8, wherein the organizer comprises:
at least one containing structure for containing objects; and
a lid pivotally connected to the containing structure, the time-and-temperature display device being mounted on the lid.

11. The playard set of claim 5, wherein the time-and-temperature display device comprises:
a case;
a circuit board disposed in the case;
a button interface connected to the circuit board and disposed on the case for performing operations of the time-and-temperature display device; and
a display interface electrically connected to the circuit board and disposed on the case for displaying the current time and the current temperature.

12. The playard set of claim 11, wherein the case comprises a front housing and a rear housing, the button interface comprises at least one front button disposed on the front housing and at least one rear button disposed on the rear housing, and the display interface is mounted on the front housing.

13. The playard set of claim 1, wherein the placing mechanism further comprises:
a ruler pattern disposed on the holding body.

14. A placing mechanism detachably disposed on an infant carrying apparatus, the placing mechanism comprising:
a first corner connecting structure and a second corner connecting structure detachably disposed on the infant carrying apparatus;
a support frame extended from the first corner connecting structure;
a holding body suspended from the support frame for holding an infant; and
a weight measuring device disposed on the first corner connecting structure and connected to the support frame for measuring a corresponding weight value when the holding body is pressed downward along with the support frame.

15. The placing mechanism of claim 14, wherein the support frame is a U-shaped tube.

16. The placing mechanism of claim 14, wherein the weight measuring device comprises a strain gage.

17. The placing mechanism of claim 14, wherein the weight measuring device has a display interface and a button interface, the display interface is used for displaying the weight value, and the button interface is used for performing operations of the weight measuring device.

18. The placing mechanism of claim 14 further comprising:
a time-and-temperature display device disposed on the second corner connecting structure for displaying a current time and a current temperature.

19. The placing mechanism of claim 18, wherein the time-and-temperature display device comprises:
a case;
a circuit board disposed in the case;
a button interface connected to the circuit board and disposed on the case for performing operations of the time-and-temperature display device; and
a display interface electrically connected to the circuit board and disposed on the case for displaying the current time and the current temperature.

20. The placing mechanism of claim 19, wherein the case comprises a front housing and a rear housing, the button interface comprises at least one front button disposed on the front housing and at least one rear button disposed on the rear housing, and the display interface is mounted on the front housing.

21. The placing mechanism of claim 14 further comprising:
a time-and-temperature display device integrated with the weight measuring device such that the weight measuring device can display a current time and a current temperature.

22. The placing mechanism of claim 14 further comprises:
a ruler pattern disposed on the holding body.

23. The placing mechanism of claim 14, wherein the infant carrying apparatus is selected from one of a playard, a stroller, a high chair and a car seat.
